(19) United States
(12) Patent Application Publication
(10) Pub. No.: US 2026/0080895 A1
(43) Pub. Date: Mar. 19, 2026

(54) SYSTEM AND METHOD FOR CLAP4SED

(71) Applicant: Robert Bosch GmbH, Stuttgart (DE)

(72) Inventors: Wei-Cheng LIN, Pittsburgh, PA (US); Ho-Hsiang WU, Morrisville, NC (US); Irtsam GHAZI, Pittsburgh, PA (US); Luca BONDI, Pittsburgh, PA (US); Ajit BELSARKAR, Lancaster, PA (US); Samarjit DAS, Wexford, PA (US)

(21) Appl. No.: 18/886,764

(22) Filed: Sep. 16, 2024

(51) Int. Cl. G10L 25/78; G10L 25/30

(52) U.S. Cl. CPC G10L 25/78; G10L 25/30

(57) ABSTRACT

A method for real-time sound event detection on an embedded device includes pretraining a contrastive language-audio pretraining model as an audio foundation model and preparing offline multimodal query prototypes for sound events of interest. The pretrained model and query prototypes are deployed on an embedded device. The device receives an input audio stream and extracts audio embeddings using the pretrained model. Similarity scores are calculated between the extracted audio embeddings and the prepared query prototypes. The presence of a sound event is determined based on the calculated similarity scores, and a real-time sound event detection result is output. The system includes a memory storing the pretrained model and query prototypes, an audio input interface, and a processor configured to perform the extraction, calculation, determination, and output operations. A non-transitory computer-readable medium stores instructions that, when executed, cause a processor to perform the method.

### TECHNICAL FIELD

Aspects of the disclosure generally relate to machine learning systems using deep reinforcement learning techniques for audio event detection and classification.

### BACKGROUND

Sound event detection (SED) has become increasingly important for monitoring our environment, complementing vision-based systems by handling occlusions better and supporting omnidirectional signals. Applications range from urban noise monitoring to tracking avian diversity and migrations. However, implementing real-time SED on embedded devices poses significant challenges, primarily related to generalizability and complexity.

Existing SED models are predominantly suited for closed-form recognition, making adaptation to new or unseen sound classes difficult. This limitation becomes particularly problematic in real-world applications where the classes of interest or acoustic conditions frequently change over time. Continuously retraining models to accommodate these changes can be prohibitively expensive and time-consuming.

Recent advancements in audio foundation models (AFMs) offer potential solutions to bridge the generalization gaps encountered with unseen acoustic events or conditions. These models, such as those based on contrastive language-audio pretraining (CLAP), unlock free-form natural language interactions with audio data and provide new avenues for embedded audio AI solutions. However, AFMs typically rely on computationally heavy model architectures, especially when accompanied by additional language models. This imposes another critical challenge for utilizing AFMs under embedded device setups.

Furthermore, the rising popularity of multimodal foundation models that utilize large language models (LLMs) has led to increased focus on prompt engineering techniques. The exploration of how to effectively prompt or design queries has emerged as a key topic for extracting desired knowledge from these models. Additionally, the modality gap poses a potential challenge for multimodal applications, with proposed solutions including the incorporation of few-shot prototypes from each modality. Given these challenges, there is a need for a SED solution that can operate in real-time on embedded devices, adapt flexibly to various deployment environments, and leverage the power of audio foundation models without incurring prohibitive computational costs.

### SUMMARY

In one or more illustrative examples, a method for real-time sound event detection on an embedded device may comprise pretraining a contrastive language-audio pretraining model as an audio foundation model. Offline multimodal query prototypes for sound events of interest may be prepared. The pretrained model and prepared query prototypes may be deployed on an embedded device. The method may include receiving an input audio stream on the embedded device and extracting audio embeddings from this stream using the pretrained model. Similarity scores between the extracted audio embeddings and the prepared query prototypes may be calculated. The presence of a sound event may be determined based on these calculated similarity scores. The method outputs a real-time sound event detection result. The contrastive language-audio pretraining model may comprise an audio encoder and a text encoder trained to optimize symmetric similarity contrastively in a joint multimodal space for audio-text pairs. The audio encoder may be a lightweight parallel audio neural network architecture. Preparing query prototypes may involve extracting audio embeddings from few-shot audio samples, generating text prompts using a large language model, extracting text embeddings, and selecting the most relevant text embedding based on similarity to the audio embeddings.

In a system aspect, an illustrative example for real-time sound event detection on an embedded device includes a memory storing a pretrained contrastive language-audio pretraining model and prepared multimodal query prototypes. An audio input interface for receiving an input audio stream may be included. A processor may be configured to extract audio embeddings from the input audio stream using the pretrained model, calculate similarity scores between the extracted audio embeddings and the prepared query prototypes, determine the presence of a sound event based on the calculated similarity scores, and output a real-time sound event detection result. The system may utilize a lightweight parallel audio neural network architecture for the audio encoder. The prepared multimodal query prototypes may comprise audio query vectors derived from few-shot audio samples and text query vectors derived from text prompts generated by a large language model. The processor may be further configured to preprocess the input audio stream to generate a spectrogram before extracting audio embeddings and may determine the presence of a sound event by applying binary thresholding to the calculated similarity scores.

In another example, a non-transitory computer-readable medium may comprise instructions that, when executed by a processor on an embedded device, facilitate real-time sound event detection. The method may include loading a pretrained contrastive language-audio pretraining model and prepared multimodal query prototypes, receiving an input audio stream, extracting audio embeddings from the input audio stream using the pretrained model, calculating similarity scores between the extracted audio embeddings and the prepared query prototypes, determining the presence of a sound event based on the calculated similarity scores, and outputting a real-time sound event detection result. These operations may be carried out using a lightweight parallel audio neural network architecture for the audio encoder, with similarity scores calculated using dot-product computations. The embedded device may comprise a chip with a quad-core processor, a single instruction, multiple data accelerator, and a computer vision flow vector processor, enabling efficient real-time processing of audio streams for sound event detection.

### BRIEF DESCRIPTION OF THE DRAWINGS

FIG. 1 illustrates an example CLAP4SED framework;

FIG. 2 illustrates an example embedded hardware setup;

FIG. 3 illustrates an example process for performing few-shot active learning for audio event detection and classification; and

FIG. 4 illustrates an example computing device for performing active learning for anomalous event detection and classification.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure describes, in one or more embodiments, a deep reinforcement active machine learning system and method for audio event detection and classification. The system may include three components: an audio event classifier, a reinforcement learning query strategy module, and a few-shot adaptation module. These components cooperate to iteratively improve the audio event detection model while minimizing the number of labeled samples required.

The contrastive language-audio pretraining model serves as an audio foundation model for sound event detection. This model, comprising an audio encoder fA(·) and a text encoder fT(·), is trained to optimize symmetric similarity contrastively in a joint multimodal space for audio-text pairs (Elizalde et al., 2023). The training process involves processing incoming pairs of audio sequences Xa and corresponding caption descriptions Xt, resulting in audio embeddings Ea=fA(Xa) and text embeddings Et=fT(Xt), respectively.

The core of the CLAP model's training is encapsulated in a sophisticated loss function, which is fundamental to the CLAP4SED system's ability to perform real-time sound event detection on embedded devices. This loss function is defined as follows:

$$L = 1 / ( 2 B ) \text{} \sum [ log diag ( softmax ( η * ( Ea \cdot Et \hat{} T ) ) ) + log diag ( softmax ( η * ( Et \cdot Ea \hat{} T ) ) ) ]$$

Where L represents the overall loss to be minimized during training, B denotes the mini-batch size used in the training process, Ea represents the audio embeddings generated by the audio encoder fA(·), Et represents the text embeddings generated by the text encoder fT(·), η is a temperature parameter that scales the similarity scores, diag(·) refers to the diagonal elements of the resulting matrix, and softmax(·) is the softmax function applied to scale the similarity scores.

This loss function is designed to optimize the symmetric similarity between audio and text embeddings within each batch, encouraging the model to learn a joint representation space where semantically related audio and text pairs are closer together. The loss function consists of two symmetric terms, which ensures that the model learns bidirectional mappings between audio and text modalities. This symmetry is crucial for the CLAP4SED system's ability to perform cross-modal retrieval and similarity computations efficiently.

The softmax function is applied to the scaled dot product similarities (η*(Ea·Et\hat{ }T) and η*(Et·Ea\hat{ }T)). This operation normalizes the similarity scores, effectively creating a probability distribution over the possible matches within the batch. The temperature parameter η allows for fine-tuning of this distribution, affecting the model's sensitivity to similarities.

By taking the logarithm of the diagonal elements (which represent the correct audio-text pairs), the loss function heavily penalizes mismatches while providing diminishing returns for very confident correct matches. This encourages the model to learn robust representations that generalize well. The factor 1/(2B) averages the loss over the batch size and the two symmetric terms, ensuring that the loss is properly scaled regardless of the chosen batch size. This normalization is important for stable training across different hardware configurations and dataset sizes.

The dot product Ea·Et\hat{ }T computes the similarity between all pairs of audio and text embeddings in the batch. This operation is highly efficient and can be optimized for parallel computation on GPUs or specialized hardware like the Ambarella CV22 chip used in our embedded system. The careful design of this loss function enables the CLAP model to learn a joint embedding space where semantically related audio and text pairs are positioned closer together. This learned representation is key to the CLAP4SED system's ability to perform efficient and accurate sound event detection using limited computational resources on embedded devices.

The audio encoder, a crucial component of this system, is designed as a lightweight parallel audio neural network architecture, optimized for efficient deployment on embedded devices. This design choice reflects the growing trend towards edge computing in audio processing applications for tasks such as noise monitoring in urban areas (Bello et al., 2019), tracking avian diversity (Kahl et al., 2021), and detecting bird migrations (Lostanlen et al., 2022). The lightweight nature of the encoder is particularly important for real-time processing on resource-constrained devices, enabling applications in diverse environments from smart cities to remote wildlife monitoring stations.

The model's architecture is carefully selected to balance performance and efficiency, taking into account the specific audio domain and the computational constraints of embedded devices. The use of a parallel audio neural network draws inspiration from architectures like PANN (Kong et al., 2020), adapted for the unique challenges of audio data. This approach allows for efficient processing of spectral and temporal features simultaneously, which is crucial for accurate sound event detection. The parallel processing nature of the architecture enables the model to capture both short-term acoustic events and long-term temporal patterns, which is essential for distinguishing between various types of sound events, from transient sounds like gunshots (Mares and Blackburn, 2021) to more sustained sounds like bird calls or urban noise.

The CLAP4SED system introduces an innovative approach to preparing offline multimodal query prototypes for sound events of interest. This process involves a sophisticated combination of audio and text processing techniques. Audio embeddings are extracted from N few-shot audio samples for each sound event of interest, leveraging transfer learning from the pretrained model. This few-shot approach is particularly valuable in scenarios where collecting large amounts of labeled data for each sound event is impractical or expensive.

Concurrently, the system generates text prompts describing each sound event using a large language model, such as GPT-4 (Brown et al., 2020). This approach to prompt engineering applies advanced natural language processing techniques to the domain of audio event detection, addressing the modality gap in multimodal applications (Liang et al., 2022). The system employs GPT-4 to rewrite conventional CLAP retrieval templates (e.g., “this is the sound of [class label]”) into M different prompts, enriching the textual representation of each sound event. This enrichment process allows for a more nuanced and context-aware representation of sound events, potentially capturing subtle semantic differences that might be crucial for accurate detection.

The text prompts are then processed to extract text embeddings, creating a bridge between the auditory and linguistic representations of sound events. The system employs a clever selection mechanism to choose the most relevant text embedding based on its similarity to the audio embeddings. Specifically, an audio-informed max-pooling operation over prompts is conducted, which returns the prompt embedding with the maximum dot-product similarity to the given few-shot audio embeddings. This results in the final text query qT ∈R1×d, where d represents the dimension of the hidden space that performs audio-text contrastive learning in the CLAP model.

This multimodal approach to creating query prototypes advances beyond traditional unimodal systems, allowing for a more comprehensive representation of sound events (Kushwaha and Fuentes, 2023). By combining audio and text modalities, the system can capture both the acoustic characteristics and the semantic descriptions of sound events, potentially leading to more robust and adaptable detection capabilities.

During real-time sound event detection, the system calculates similarity scores between the extracted audio embeddings from the input audio stream and the prepared query prototypes. This calculation typically involves computing the dot-product between these embeddings, a method chosen for its computational efficiency and effectiveness in high-dimensional spaces. The presence of a sound event is then determined by applying a binary thresholding to the calculated similarity scores, forming an averaged decision score across modalities. This decision-making process can be tuned for different sensitivity requirements, allowing the system to adapt to various deployment scenarios with different false positive and false negative tolerances.

The CLAP4SED system's ability to adapt to new types of sound events without extensive retraining is a noteworthy feature. By leveraging few-shot learning techniques and the flexibility of the contrastive language-audio pretraining model, the system can quickly incorporate new sound events into its detection repertoire. This adaptability is crucial in real-world applications where the acoustic environment may change rapidly or unpredictably, such as in detecting various urban sounds like gunshots (Mares and Blackburn, 2021), glass breaking (Suliman et al., 2020), or emerging environmental sounds that may be indicators of ecological changes.

The real-time operation of CLAP4SED on embedded devices represents a significant engineering achievement. The system may be designed to run on hardware such as the Ambarella CV22 chip, which is typically used for IP cameras. This chip may come equipped with a quad-core ARM A-53 Linux-enabled processor, 1MB L2 cache, a Neon SIMD accelerator for digital signal processing (DSP), and a computer vision (CV) flow vector processor for deep learning matrix operations. The Neon chip can effectively accelerate the Fast-Fourier transform (FFT) for spectrogram computations, which is crucial for efficient audio processing.

In the online SED predictor phase, only the lightweight audio encoder and modality-specific query vectors need to be pre-stored in the embedded device. Upon receiving an input audio streaming data chunk (with window size L), the encoder fA(⋅) extracts it to generate key embeddings k∈R1×d. These embeddings are then used to calculate a predefined similarity criterion with the prepared queries, forming the basis for sound event detection decisions.

The minimum real-time prediction time grid, denoted as τ, depends on the overall latency of the prediction process. This system design allows for continuous processing of input audio streams, extracting audio embeddings, calculating similarity scores, and outputting detection results with minimal latency. This real-time capability, combined with the system's adaptability, makes it suitable for a wide range of applications, from smart home devices to industrial monitoring systems and environmental sensing networks (Mesaros et al., 2021).

Optimizing the CLAP4SED system involves careful consideration of various components. The architecture of the audio encoder can be fine-tuned to achieve the optimal balance between detection accuracy and computational efficiency on the target embedded device. This might involve techniques such as model compression through distillation and quantization (Polino et al., 2018), which could further reduce the computational requirements without significantly impacting detection performance. The process of generating query prototypes can be refined through iterative experimentation, potentially incorporating active learning techniques to identify the most informative examples for each sound event.

Evaluation of the CLAP4SED system would typically involve comprehensive experiments on benchmark sound event detection datasets such as AudioSet (Gemmeke et al., 2017) or ESC-50. Performance metrics would include accuracy and F1-score as well as real-time performance indicators such as detection latency and computational resource utilization. The system's ability to adapt to new sound events with minimal additional data would be a key focus of evaluation, potentially using few-shot learning benchmarks adapted for the audio domain. These evaluations would help to quantify the system's effectiveness across a range of sound event types and acoustic environments, providing insights into its generalization capabilities and potential areas for improvement.

The CLAP4SED system offers several technological advantages over existing approaches to sound event detection. Its use of a pretrained contrastive language-audio model allows for handling of a wide range of sound events without the need for extensive task-specific training. This approach leverages the power of transfer learning, which has significantly impacted many areas of machine learning in recent years (Lin et al., 2023). The system's ability to operate effectively with limited labeled data makes it particularly valuable in domains where obtaining large amounts of annotated audio data is challenging or costly.

The system's use of multimodal query prototypes, incorporating both audio and textual information, represents an innovative approach to sound event representation. This multimodal approach allows for flexible adaptation to new sound events, potentially capturing semantic information that might be missed by purely audio-based systems (Huang et al., 2024). By bridging the gap between acoustic features and linguistic descriptions, CLAP4SED can potentially achieve more nuanced and context-aware sound event detection, adapting more readily to diverse and changing acoustic environments.

The ability of CLAP4SED to operate in real-time on embedded devices aligns with the growing trend towards edge computing in IoT and smart device applications. This capability opens up new possibilities for sound event detection in resource-constrained environments, from wildlife monitoring in remote areas to noise pollution tracking in urban settings (Lostanlen et al., 2022). The system's efficiency and adaptability make it suitable for deployment in a wide range of scenarios, potentially enabling new applications in fields such as environmental monitoring, security, and assistive technologies.

The CLAP4SED system represents an advancement in the field of sound event detection, combining state-of-the-art machine learning techniques with practical considerations for real-world deployment. Its innovative use of contrastive learning, multimodal representations, and efficient embedded processing paves the way for more widespread and effective use of audio event detection technology across a diverse range of applications. As the field of audio AI continues to evolve, systems like CLAP4SED are likely to play an increasingly important role in our ability to understand and interact with the acoustic world around us.

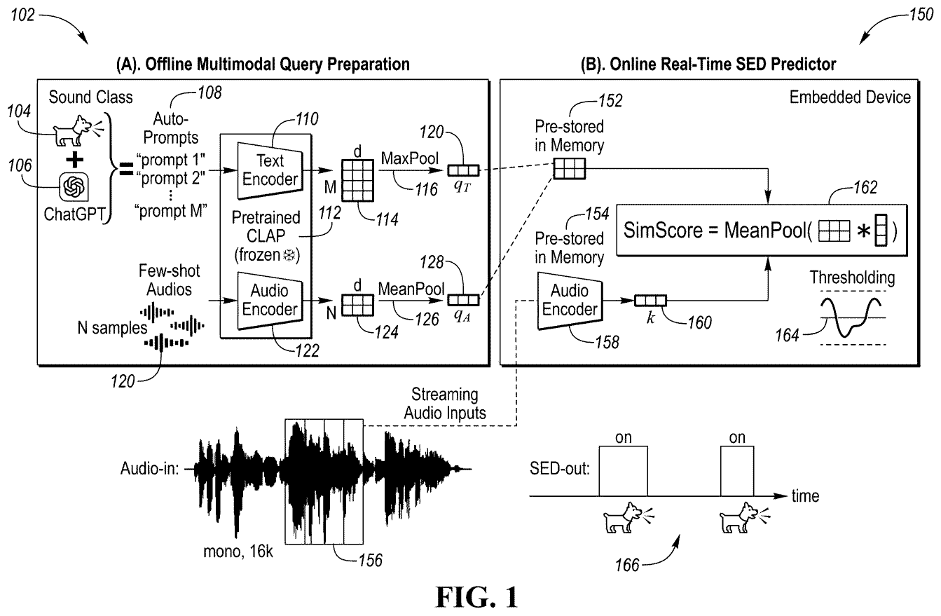

FIG. 1 shows a CLAP4SED system 100 for real-time sound event detection (SED) on embedded devices, having two main components: (A) Offline Multimodal Query Preparation 102 and (B) Online Real-Time SED Predictor 150. In the Offline Multimodal Query Preparation phase 102: The process begins with a Sound Class 104, represented by a dog icon. This Sound Class 104 is input to a ChatGPT-like language model 106 for Auto-Prompts generation. The language model 106 produces M different prompts 108 such as “prompt 1”, “prompt 2”, up to “prompt M”. This auto-prompt generation enriches the textual representation of the sound class, enabling more robust query vectors.

These prompts 108 are fed into a Text Encoder 110, which is part of a pretrained CLAP (Contrastive Language-Audio Pretraining) model 112. The CLAP model 112 is labeled as “Pretrained CLAP (frozen)” to indicate that its weights remain fixed during this process. The Text Encoder 110 outputs a d×M dimensional matrix of text embeddings 114, where d represents the embedding dimension and M is the number of prompts. An audio informed MaxPool operation 116 is applied to this dimensional matrix of text embeddings 114, resulting in the final text query qT 118, a d-dimensional vector represented by a green rectangle. This max-pooling operation selects the most salient features across all prompt embeddings associated with the given few-shot audios, creating a compact yet informative text representation.

Concurrently, N Few-shot Audio samples 120 of the sound class are processed through the Audio Encoder 122 of the pretrained CLAP model 112. These N Few-shot Audio samples 120 120 are visually represented by three waveform icons labeled “N samples”. The Audio Encoder 122 generates a d×N dimensional matrix of audio embeddings 124, where N is the number of few-shot audio samples. A MeanPool operation 126 is applied to this matrix 124, producing the final audio query qA 128, also a d-dimensional vector represented by a yellow rectangle. This mean-pooling operation averages the embeddings across all few-shot samples, creating a representative audio embedding prototype for the sound class.

In the Online Real-Time SED Predictor phase 150 on the Embedded Device: The pre-computed query vectors qT 118 and qA 128 are stored in the device's memory 152 and 154, respectively. This is indicated by dashed lines connecting them to the embedded device section, emphasizing the transfer of offline-computed queries to the online system. An input audio stream 156, labeled “Audio-in”, is continuously fed into the system. This is visually represented by a waveform with the label “mono, 16K” indicating its characteristics-a mono channel audio signal sampled at 16 kHz.

The Audio Encoder 158, also stored on the device, processes the input audio stream 156 to generate key embeddings k 160. This Audio Encoder 158 is a lightweight version of the CLAP audio encoder, optimized for real-time processing on embedded devices. A similarity score (SimScore) is computed 162 using a mean pooling operation on the dot product of the pre-computed query vectors qT 118 and qA 128 stored in the device's memory 152 and 154 and the key embeddings 160. This operation is explicitly shown in the formula: “SimScore=MeanPool([qT; qA]*k)”. This computation effectively measures the similarity between the input audio and the pre-computed query vectors in the shared embedding space.

Finally, a thresholding operation 164 is applied to the similarity score to determine the presence or absence of the sound event. This is visually represented by a threshold curve icon, indicating that the system can be tuned for different sensitivity levels. The output (SED-out) 166 shows the detection results over time, with “on” indicators when the sound event (represented by the dog icon) is detected. This is visualized as a timeline with orange blocks indicating detection periods, demonstrating the system's ability to perform continuous real-time sound event detection.

This CLAP4SED framework enables efficient real-time sound event detection by leveraging pre-computed query vectors 118, 128 and the Audio Encoder 158 on the embedded device, making it suitable for resource-constrained environments. The innovative use of both textual (qT) and audio (qA) query vectors enhances the system's robustness and adaptability to various acoustic conditions and linguistic descriptions of sound events.

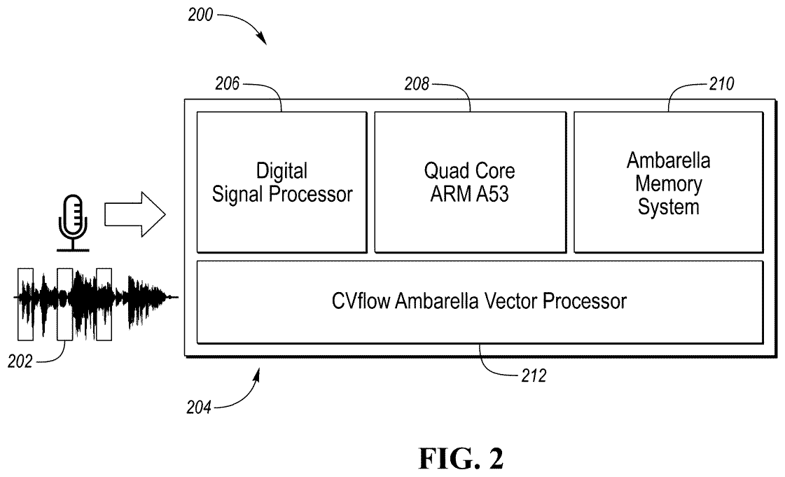

FIG. 2 illustrates the hardware architecture 200 of the embedded device utilized in the CLAP4SED system 100 for real-time sound event detection in FIG. 1. This figure demonstrates the components that enable efficient processing of audio signals and execution of the sound event detection algorithm. The input audio signal 202 is represented by a microphone icon and an accompanying waveform, indicating the system's ability to capture and process real-time audio streams, corresponds to receiving an input audio stream on the embedded device.

The captured audio signal is then fed into the Ambarella chip 204, which is enclosed within a border, representing the integrated system-on-chip (SoC) architecture. The Ambarella chip 204 comprises several components: The Digital Signal Processor (DSP) 206, is responsible for the initial processing of the incoming audio signal. This component may handle tasks such as audio preprocessing and spectrogram generation, preprocessing the input audio stream to generate a spectrogram before extracting audio embeddings.

Adjacent to the DSP is a multi core processor 208, which may be a multi-core ARM A53 processor central to executing the CLAP4SED algorithm, including extracting audio embeddings from the input audio stream using the pretrained contrastive language-audio pretraining model and calculating similarity scores between the extracted audio embeddings and the prepared multimodal query prototypes. The Ambarella Memory System 210, provides the necessary storage for the pretrained models, pre-computed query prototypes, and runtime data. This allows for deploying the pretrained contrastive language-audio pretraining model and prepared query prototypes on an embedded device.

At the bottom of the chip diagram is the CVflow Ambarella Vector Processor 212, spanning the full width of the chip representation. This specialized processor is designed for efficient execution of computer vision and machine learning tasks. In the context of CLAP4SED, it accelerates operations such as the dot-product calculations between audio embeddings and query prototypes, and the subsequent mean pooling operation described in the claims.

The overall architecture of the Ambarella chip 204, with its combination of a DSP 206, the processor 208, Ambarella Memory System 210, and Ambarella Vector Processor 212, embodies a chip with a quad-core processor, a single instruction, multiple data accelerator, and a computer vision flow vector processor. This hardware configuration may specifically designed to meet the computational demands of real-time sound event detection while maintaining the power efficiency required for embedded applications. By leveraging this specialized hardware, the CLAP4SED system 100 may efficiently perform the operations of audio embedding extraction, similarity score calculation, and thresholding to determine the presence of sound events, all in real-time on a resource-constrained embedded device.

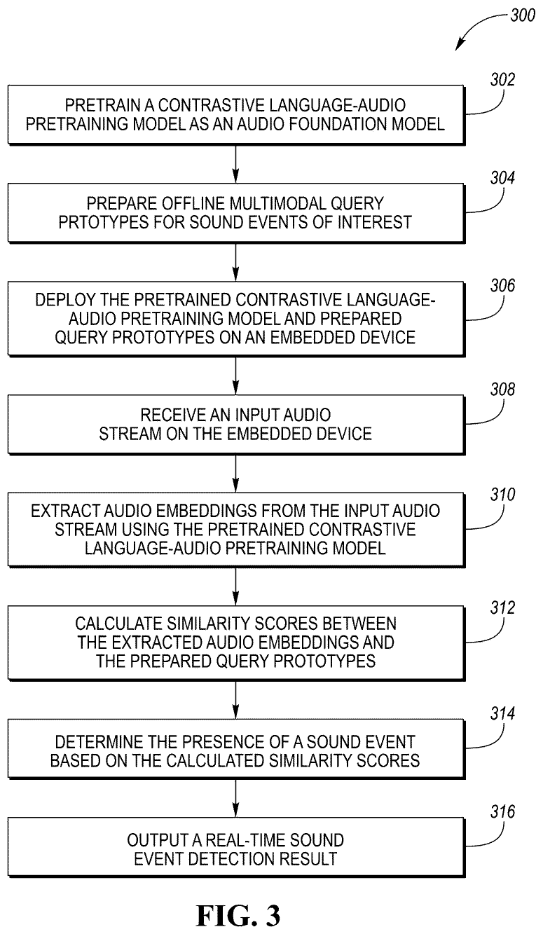

FIG. 3 illustrates a process 300 of the CLAP4SED system for real-time sound event detection on embedded devices according to one or more embodiments. This process encompasses a comprehensive approach to efficient and adaptable sound event detection, leveraging advanced machine learning techniques and optimized hardware implementation.

The process begins with pretraining a contrastive language-audio pretraining model as an audio foundation model, as set forth in step 302. This crucial step involves training both an audio encoder and a text encoder to optimize symmetric similarity contrastively in a joint multimodal space for audio-text pairs. The audio encoder may specifically be designed as a lightweight parallel audio neural network architecture, balancing computational efficiency with performance to suit embedded device constraints. This pretraining process may be fundamental to the system's ability to generate meaningful audio embeddings for diverse sound events.

Next, offline multimodal query prototypes for sound events of interest are prepared, as depicted in step 304. This sophisticated process involves extracting audio embeddings from few-shot audio samples for each sound event of interest. Typically, N samples are used per sound event, where N is a small positive integer, enabling the system to learn from limited examples. The system then generates text prompts describing each sound event using a large language model. This step involves rewriting conventional contrastive language-audio pretraining retrieval templates (e.g., “this is the sound of [class label]”) to enrich text expressiveness, capturing nuanced descriptions of sound events. Text embeddings are then extracted from these generated text prompts. Finally, the system selects the most relevant text embedding based on its similarity to the audio embeddings, creating a robust multimodal representation for each sound event.

The pretrained contrastive language-audio pretraining model and prepared query prototypes are then deployed on an embedded device, as shown in step 306. This embedded device typically comprises a specialized chip with a quad-core processor, a single instruction, multiple data (SIMD) accelerator, and a computer vision flow vector processor. These hardware specifications are crucial for enabling real-time processing capabilities.

The process continues with receiving an input audio stream on the embedded device, as indicated in step 308. Before further processing, the system may preprocess the input audio stream to generate a spectrogram, enhancing the signal's time-frequency representation for more effective feature extraction.

Audio embeddings are then extracted from the input audio stream (or its spectrogram) using the pretrained contrastive language-audio pretraining model, as illustrated in step 310. This step leverages the pretrained audio encoder to efficiently convert the audio input into a compact, semantically rich representation.

The system then calculates similarity scores between the extracted audio embeddings and the prepared query prototypes, as shown in step 312. This computation typically involves calculating the dot product between the embeddings, a method chosen for its computational efficiency and effectiveness in high-dimensional spaces.

Based on the calculated similarity scores, the presence of a sound event is determined, as depicted in step 314. This determination usually involves applying a binary thresholding technique to the similarity scores. The thresholding can be tuned to balance between detection sensitivity and false alarm rates, adapting to different operational requirements.

Finally, the process outputs a real-time sound event detection result, as shown in step 316. This output indicates whether specific sound events of interest have been detected in the input audio stream, providing timely information for various applications such as urban noise monitoring, wildlife tracking, or security systems.

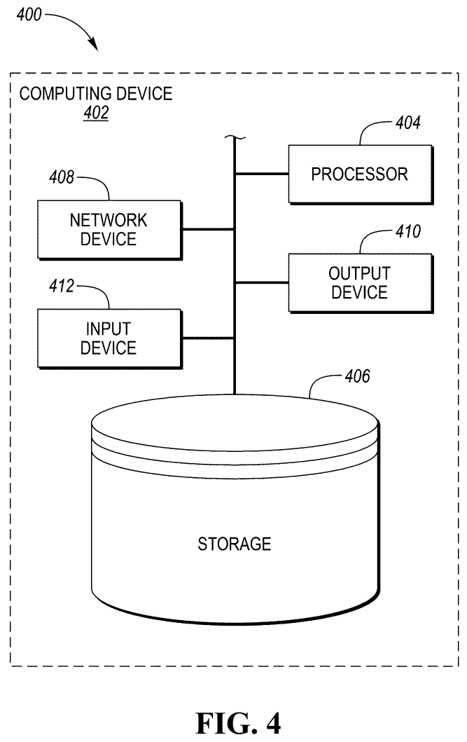

Throughout this process, the CLAP4SED system leverages its unique architecture to perform real-time sound event detection with minimal computational overhead. The use of pre-computed query prototypes and a pretrained model allows for efficient processing on resource-constrained embedded devices. The system's ability to work with few-shot examples and leverage both audio and textual information makes it highly adaptable to new sound events and diverse acoustic environments. FIG. 4 illustrates an example 400 of a computing device 402 for implementing the CLAP4SED system for real-time sound event detection on embedded devices. As shown, the computing device 402 includes a processor 404 that is operatively connected to a memory 406, a network device 408, an output device 410, and an input device 412. It should be noted that this is merely an example, and computing devices 402 with more, fewer, or different components may be used.

The processor 404 may include one or more integrated circuits that implement the functionality of a central processing unit (CPU) and/or graphics processing unit (GPU). In some examples, the processors 404 are a system on a chip (SoC) that integrates the functionality of the CPU and GPU. The SoC may optionally include other components such as, for example, the memory 406 and the network device 408 into a single integrated device. In other examples, the CPU and GPU are connected to each other via a peripheral connection device such as peripheral component interconnect (PCI) express or another suitable peripheral data connection. In one example, the CPU is a commercially available central processing device that implements an instruction set such as one of the x86, ARM, Power, or microprocessor without interlocked pipeline stage (MIPS) instruction set families.

Regardless of the specifics, during operation the processor 404 executes stored program instructions that are retrieved from the memory 406. The stored program instructions include software that controls the operation of the processors 404 to perform the CLAP4SED process described herein. The processor 404 can execute complex algorithms involved in the contrastive learning process, preparing query prototypes, extracting audio embeddings, calculating similarity scores, and performing real-time sound event detection.

The memory 406 may include both non-volatile memory and volatile memory devices. The non-volatile memory includes solid-state memories, such as NOR and NAND flash memory, magnetic and optical storage media, or any other suitable data storage device that retains data when the system is deactivated or loses electrical power. The volatile memory includes static and dynamic random-access memory (RAM) that stores program instructions and data during operation of the CLAP4SED system. The network device 408 can be in communication with sensor systems to receive audio data and store it in the memory 406. Alternatively, the memory 406 may already contain audio data from the sensor systems.

The GPU may include hardware and software for processing and display of the audio data, intermediate features, and detection results. The output device 410 is configured to present the results of the sound event detection process in an understandable format for human operators. The output device 410 may include a graphical or visual display device, such as an electronic display screen, projector, printer, or any other suitable device that reproduces a graphical display. As another example, the output device 410 may include an audio device, such as a loudspeaker or headphone.

The input device 412 may include various devices that enable the computing device 402 to receive control input from users. The input device 412 enables users to interact with the computing device, to configure the CLAP4SED process, adjust detection thresholds, and refine operational parameters based on performance evaluations. Examples of suitable input devices that receive human interface inputs may include keyboards, mice, trackballs, touchscreens, voice input devices, graphics tablets, and the like.

The network devices 408 may each include various devices that enable sending and receiving data from external devices over networks. Examples of suitable network devices 408 include an Ethernet interface, a Wi-Fi transceiver, a cellular transceiver, a Bluetooth or BLE transceiver, UWB transceiver, or other network adapter or peripheral interconnection device that receives data from another computer or external data storage device, which can be useful for receiving large sets of audio data in an efficient manner.

This hardware configuration, particularly when implemented with specialized components like the Ambarella CV22 chip, provides the necessary computational power and efficiency for real-time sound event detection. The combination of a powerful processor, efficient memory management, and versatile networking capabilities allows the CLAP4SED system to perform complex operations such as audio embedding extraction, similarity score calculation, and binary thresholding with minimal latency, making it suitable for deployment in resource-constrained embedded environments. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps. The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole. The phrase “consisting essentially of” limits the scope of a claim to the specified materials or steps, plus those that do not materially affect the basic and novel characteristic(s) of the claimed subject matter. The term “one or more” means “at least one” and the term “at least one” means “one or more.” The terms “one or more” and “at least one”include “plurality” as a subset.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

What is claimed is:

1. A method for real-time sound event detection on an embedded device, comprising:
pretraining a contrastive language-audio pretraining model as an audio foundation model;
preparing offline multimodal query prototypes for sound events of interest;
deploying the pretrained contrastive language-audio pretraining model and prepared query prototypes on an embedded device;
receiving an input audio stream on the embedded device;
extracting audio embeddings from the input audio stream using the pretrained contrastive language-audio pretraining model;
calculating similarity scores between the extracted audio embeddings and the prepared query prototypes;
determining the presence of a sound event based on the calculated similarity scores; and
outputting a real-time sound event detection result.

2. The method of claim 1 wherein pretraining the contrastive language-audio pretraining model comprises:
training an audio encoder and a text encoder to optimize symmetric similarity contrastively in a joint multimodal space for audio-text pairs.

3. The method of claim 2 wherein the audio encoder is a lightweight parallel audio neural network architecture.

4. The method of claim 1 wherein preparing offline multimodal query prototypes comprises:
extracting audio embeddings from few-shot audio samples for each sound event of interest;
generating text prompts describing each sound event using a large language model;
extracting text embeddings from the generated text prompts; and
selecting the most relevant text embedding based on similarity to the audio embeddings.

5. The method of claim 4 wherein the few-shot audio samples comprise N samples per sound event of interest, where N is a small positive integer.

6. The method of claim 4 wherein generating text prompts comprises rewriting a conventional contrastive language-audio pretraining retrieval template using a large language model to enrich text expressiveness.

7. The method of claim 1 wherein calculating similarity scores comprises:
computing a dot-product between the extracted audio embeddings and the prepared query prototypes.

8. The method of claim 1 wherein determining the presence of a sound event comprises:
applying a binary thresholding to the calculated similarity scores.

9. The method of claim 1 wherein the embedded device comprises a chip with a quad-core processor, a single instruction, multiple data accelerator, and a computer vision flow vector processor.

10. The method of claim 1 further comprising:
preprocessing the input audio stream to generate a spectrogram before extracting audio embeddings.

11. A system for real-time sound event detection on an embedded device, comprising:
a memory storing a pretrained contrastive language-audio pretraining model and prepared multimodal query prototypes;
an audio input interface for receiving an input audio stream;
a processor configured to:
extract audio embeddings from the input audio stream using the pretrained contrastive language-audio pretraining model,
calculate similarity scores between the extracted audio embeddings and the prepared query prototypes,
determine the presence of a sound event based on the calculated similarity scores, and
output a real-time sound event detection result.

12. The system of claim 11 wherein the pretrained contrastive language-audio pretraining model comprises an audio encoder and a text encoder trained to optimize symmetric similarity contrastively in a joint multimodal space for audio-text pairs.

13. The system of claim 12 wherein the audio encoder is a lightweight parallel audio neural network architecture.

14. The system of claim 11 wherein the prepared multimodal query prototypes comprise audio query vectors and text query vectors for each sound event of interest.

15. The system of claim 14 wherein the audio query vectors are derived from few-shot audio samples for each sound event of interest.

16. The system of claim 14 wherein the text query vectors are derived from text prompts generated by a large language model describing each sound event of interest.

17. The system of claim 11 wherein the processor is further configured to:
preprocess the input audio stream to generate a spectrogram before extracting audio embeddings.

18. The system of claim 11 wherein the processor is configured to determine the presence of a sound event by applying a binary thresholding to the calculated similarity scores.

19. The system of claim 11 wherein the embedded device comprises a chip with a quad-core processor, a single instruction, multiple data accelerator, and a computer vision flow vector processor.

20. A non-transitory computer-readable medium storing instructions that, when executed by a processor on an embedded device, cause the processor to perform real-time sound event detection by:
loading a pretrained contrastive language-audio pretraining model and prepared multimodal query prototypes;
receiving an input audio stream;
extracting audio embeddings from the input audio stream using the pretrained contrastive language-audio pretraining model;
calculating similarity scores between the extracted audio embeddings and the prepared query prototypes;
determining the presence of a sound event based on the calculated similarity scores; and
outputting a real-time sound event detection result.
